(19) United States
(12) Patent Application Publication
(10) Pub. No.: US 2012/0093992 A1
(43) Pub. Date: Apr. 19, 2012

(54) APPARATUS AND METHOD FOR STRIPPING WORT

(75) Inventors: Peter Gattermeyer, Freising (DE); Christian Dorr, Haag An Der Amper (DE)

(73) Assignee: KRONES AG, NEUTRAUBLING (DE)

(21) Appl. No.: 13/128,682

(22) PCT Filed: Oct. 30, 2009
(86) PCT No.: PCT/EP09/07794

§ 371 Date: Jun. 8, 2011

(30) Foreign Application Priority Data
Nov. 11, 2008 (DE) 10.2008.056.744.2

(51) Int. Cl. C12C 7/22; C12C 7/28; C12C 7/06

(52) U.S. Cl. 426/492; 99/278; 159/13.1

(57) ABSTRACT

An apparatus and a method for stripping wort, with the apparatus including a receptacle that has a wort inlet and a wort outlet, and a heater on the side wall of the receptacle as well as a distributor device which applies the wort to the heating surface of the heater, such that the wort runs down the heating surface as a film.

### CROSS-REFERENCE TO RELATED APPLICATION

The present application claims the benefit of priority of International Patent Application No. PCT/EP2009/007794, filed Oct. 30, 2009, which application claims priority of German Application No. 102008056744.2, filed Nov. 11, 2008. The entire text of the priority application is incorporated herein by reference in its entirety.

### FIELD OF THE DISCLOSURE

The disclosure relates to an apparatus and a method for stripping wort.

### BACKGROUND

It is well-known that in beer production, various steps, which are schematically shown in FIG. 7, are passed in the brewhouse process. Malt gets from a malt silo into the store tank (A) of the malt mill (B) and is crushed in a suitable manner. Subsequently, mashing (step C), lautering (step D), wort boiling (step) E), the removal of hot break, in particular by means of a whirlpool (step F), and cooling of the wort by means of a wort cooler (step G) are performed.

During wort preparation, undesired flavors are formed which can impart an undesired odor or taste to the beer. One example of such an undesired substance is dimethyl sulfide which is formed from an inactive precursor substance contained in the malt during heating or boiling. Only low quantities of dimethyl sulfide (hereinafter referred to as DMS) are contained in the malt. During the boiling process of the wort, the inactive precursor is split into DMS and an active precursor. The DMS is only partially stripped during the boiling process in the wort copper or the heating process in the mash copper. So, after the boiling process in the wort copper, DMS is still contained in the wort copper. The active precursor DMSP, which is further decomposed during the whirlpool rest and then forms again free DMS, is still present, which affects the later beer quality.

Subsequent to wort boiling, the wort is directed into the whirlpool to separate off the hot break. During the whirlpool rest, the wort remains at temperatures just below the boiling temperature, where substances which can only be evaporated to a low degree can be formed again. In the finished beer, these components lead to undesired flavors again and affect taste stability. Thus, DMS is formed again from the inactive precursor substance, e.g. during the heat retention time.

To be able to also remove other undesired substances from the wort, a so-called “wort stripping” process was suggested (D. Seldeslachts et al. “Monatsschrift für Brauwissenschaft”, Issue 3/4, 1997, page 76, PCT WO 97/15654). In such a wort stripping process, the wort is guided into a kettle constituted as a column where vapor flows through it. This vapor takes along, among other things, a portion of the DMS and discharges it through a vent pipe. Such a system, however, is complicated.

### SUMMARY OF THE DISCLOSURE

Starting from this prior art, it is an aspect of the present disclosure to provide an apparatus and a method by means of which the stripping of undesired flavors, in particular DMS, from the wort in beer production can be carried out easily, efficiently and at low costs, and which are in particular also advantageous for small breweries with a small brew cycle.

According to the present disclosure, an apparatus for stripping wort in which the hot break has already been separated off is provided, where a heater is provided at the side wall. The heater can be provided over large surfaces outside or inside at the side wall, or it can be integrated in the latter. A distributor device can then apply the wort to the heating surface such that the wort runs down the heating surface. By the distributor device, the wort can run down the heating surface as a fine film. By the wort contacting the heated rib, the DMS formed again in the whirlpool is effectively reduced without heating the wort excessively. So, undesired flavors can easily evaporate. Such a stripping means can be manufactured very easily and inexpensively. Such an apparatus is also particularly well suited for a continuous brewing process. Stripping means stripping undesired flavors from the wort.

Advantageously, the apparatus is embodied as a mash and/or wort copper. Mash copper here means a mash tun copper or a mash copper. The concept—to realize the evaporation of undesired flavors by means of a rib heater across which the wort runs down laterally—can be easily integrated into a mash and/or wort copper.

For example, if the apparatus is also used as a wort copper, the wort can be supplied again, after the whirlpool, to the wort copper for stripping. Thus, no separate apparatus in addition to the wort copper is required. It is particularly advantageous for the apparatus to be designed as combined mash wort copper. Thus, mashing, wort boiling and stripping can be carried out with only one device. Such an apparatus is in particular suited for small breweries with a small brew number. This also involves a reduced demand of cleansing agents as well as a saving of time.

If the apparatus is embodied as a mash and/or wort copper, it advantageously has an agitator and/or a circulation device which circulates the contents in the receptacle. Such a circulation means can comprise, for example, a circulation pump which pumps the contents out of the receptacle and supplies it again in a corresponding line.

The agitator and the flow guided by means of the circulation device for example reduce fouling during wort boiling.

Advantageously, the distributor device is embodied as an umbrella-type deflection, in particular a double umbrella, which is arranged essentially in the central region of the receptacle and directs the wort to the outside towards the heating surface. As an alternative, however, the wort could also be applied from above onto an umbrella-type distributor, or else via a ring line.

By the use of an umbrella-type distributor in combination with the heated side walls, the total evaporation can be reduced resulting in a low consumption of primary energy. By means of the umbrella-type distributor, the wort can be particularly easily applied from above to the heating surfaces.

It is advantageous for the heating surface facing inwards to comprise a plurality of unevenness. In particular, the heating surface can then comprise a plurality of inflated pockets arranged one next to and above the other which are in communication with each other and through which a heating medium flows. A heating surface formed in this manner permits good heat transfer. Due to micro-turbulences at the surface, volatile matters can particularly well evaporate. Heating surfaces embodied in this manner, however, are not only advantageous for stripping but also advantageous for the wort boiling and/or mashing process, as here, too, there are higher heating rates and fouling can be reduced. By the improved heating rate, the temperature of the heating medium can be reduced, which is technologically desired and can additionally save energy.

Advantageously, the apparatus is designed as a pressure tank for overpressure and vacuum. Thus, the apparatus is also applicable for methods of wort boiling which take place in a vacuum or under overpressure.

According to a preferred embodiment, the inlet of the apparatus is connected with a whirlpool and the wort outlet with a wort cooler, where a bypass device between the whirlpool and the cooler is provided for adjusting the ratio of stripped wort to unstripped wort. This means that one portion of the wort from the whirlpool is stripped and another one directly flows from the whirlpool to the wort cooler, having the advantage that thermal stress in wort preparation can be still further reduced and the contents of flavors can be flexibly adjusted.

In the method according to the disclosure, the wort is discharged at the lower end of the apparatus, so that the wort does not rise above a certain level in the receptacle during stripping. The wort level is preferably below the heating surface. Thus, not the complete heating surface is covered by the wort in the receptacle, so that the wort can continuously run down the surfaces of the heating surface. This also prevents the wort from being excessively stressed by the heater which would result in undesired flavors forming again.

The method according to the disclosure for manufacturing wort comprises the following steps: mashing, lautering, wort boiling, hot break separation, stripping of volatile matters from the wort and cooling of the wort. According to the present disclosure, the wort is, during stripping, distributed on the heated side wall of an apparatus by a distributor device and then runs down the heating surface. As explained above, volatile matters can escape from the wort in the process.

In accordance with the disclosure, wort boiling can be carried out in a wort copper, where after hot break separation, the wort is again supplied to this wort copper and the wort copper is then used as an apparatus for stripping. This means that the wort is then directed in the wort copper at least temporarily over the distributor device to the heating surfaces. As one and the same distributor device is suited both for introducing and circulating wort during the wort boiling process and for applying the wort to the heating surfaces of the side walls, one and the same device can be used both for wort boiling and for stripping.

According to another embodiment, mashing can be carried out in a mash copper, and after hot break separation, the wort can be supplied again to the mash copper, where the mash copper is then used for stripping. In a particularly advantageous manner, a combined mash and wort copper is used, which then is used for mashing, wort boiling and stripping.

The temperature of the heating surface is some degrees above the boiling temperature, preferably within a range of 103° C. to 130° C., preferably 105° C. to 115° C. (in pressure boiling correspondingly higher and in vacuum boiling lower). These temperature ranges are suited to strip a maximum possible amount of undesired volatile matters without simultaneously generating undesired flavors again.

In wort it is advantageous if a portion of the lautered wort is first introduced into the apparatus for stripping via a wort inlet until the jet nozzle is covered. This has the advantage that less oxygen is absorbed, where subsequently the remaining wort of the brew is preferably introduced via the distributor device.

### BRIEF DESCRIPTION OF THE DRAWINGS

The disclosure will be illustrated below in greater detail with reference to the accompanying figures. In the figures:

FIG. 1 shows a schematic longitudinal section through an embodiment in accordance with the disclosure,

FIG. 2 shows a schematic longitudinal section through another embodiment in accordance with the disclosure,

FIG. 3 shows a perspective representation of the heating surface of the apparatus according to the disclosure,

FIG. 4 shows a partial longitudinal section through the heater according to the disclosure,

FIG. 5 shows across-section through the heater,

FIG. 6a shows in a schematic representation the brewhouse process according to a first embodiment of the disclosure,

FIG. 6b shows in a schematic representation a second embodiment of the brewhouse process,

FIG. 6c shows in a schematic representation a third embodiment of the brewhouse process according to the disclosure,

FIG. 7 show/s in a schematic representation a conventional brewhouse process.

### DETAILED DESCRIPTION OF THE PREFERRED EMBODIMENT

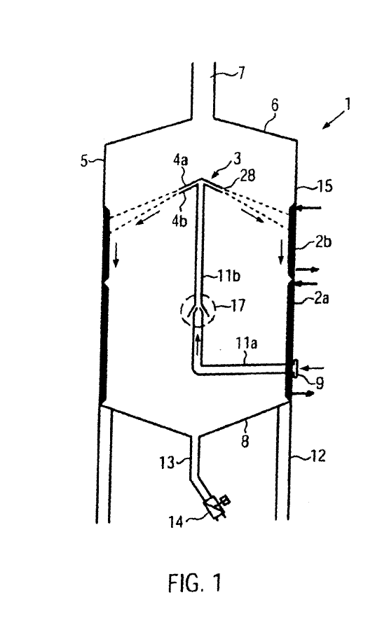

FIG. 1 shows a longitudinal section through a first embodiment of the disclosure. FIG. 1 shows an apparatus 1 for stripping wort. The apparatus 1 comprises a receptacle 5 whose side wall 15 preferably has a hollow cylindrical design. The receptacle 5 has a hood or a cover 6 in which a vent pipe 7 for volatile matters is provided. At the lower cud, the receptacle comprises a bottom 8 which preferably tapers towards the bottom. At the lowermost point of the bottom 8, an inlet or outlet 13 is provided. In the outlet line, a control valve 14 is arranged. In its lower region, the apparatus comprises an inlet 9 for wort. The inlet pipe 11a, which passes over into the rising pipe 11b, extends from the inlet 9. At the upper end of the rising pipe 11b, a distributor device 3 is provided. The distributor device 3 is embodied as an umbrella-type distributor. The umbrella-type distributor is an umbrella-type deflection which comprises at least one lower umbrella 4b which has a passage for wort through which wort exits from the rising tube towards the top and is distributed essentially radially outwards over the umbrella surface. Advantageously, the distributor device is embodied as double umbrella as is represented in FIG. 1. Here, above the first umbrella-type deflection 4b, a second umbrella-type deflection 4a is embodied at a distance to the lower umbrella-type deflection. An annular outlet opening 28 results. By this arrangement, the wort can be selectively distributed in the direction of the side wall 15, as is represented by the arrows. At the side wall of the receptacle 5, at least over a portion of the height, a preferably essentially hollow cylindrical heater 2a, 2b is provided. The distance between the distributor device 3 and the heating surface is selected such that the wort hits the upper region of the heating surface and can run down the heating surface as a thin film, as is indicated by the arrows. The distributor device 3 is here arranged in the upper end region of the heater 2a, b, or above the heater. The heater is embodied as a wall (rib heating surface) through which a heater medium flows. The temperature of the heating surface is about 103° C. to 130° C. The heating surface can be heated to the required temperatures of generally above 100° C. by vapor or another heating medium and preferably extends over more than 50% of the complete receptacle wall surface.

The heater shown in FIG. 1 comprises at least two sections 2a, 2b that can independently receive a flow, so that the heating surfaces can be heated independently. Thus, the size and the temperature of the different sections can be adapted to certain processes. During stripping, i.e. while the wort is running down the heating surface, wort is constantly drained from the apparatus via the wort outlet 13, so that the wort level does not rise to the region of the heater 2a, if possible, to permit efficient evaporation. This can be realized by the control valve or optionally by a corresponding control means.

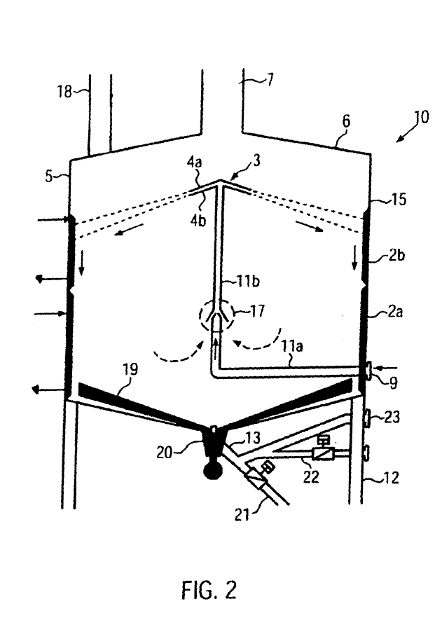

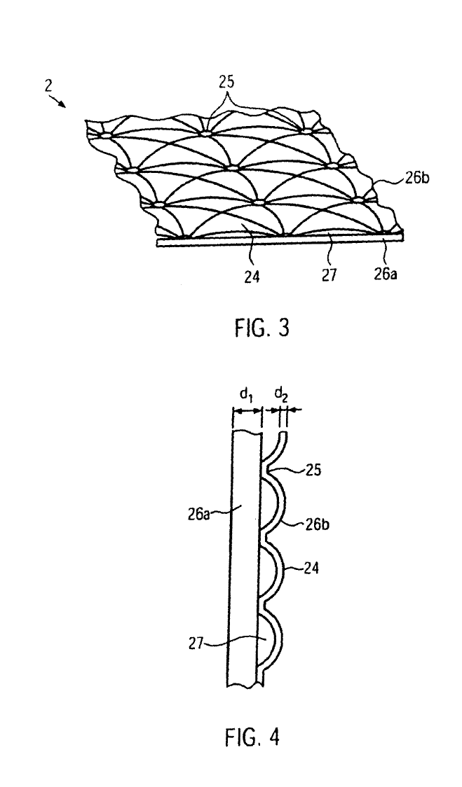

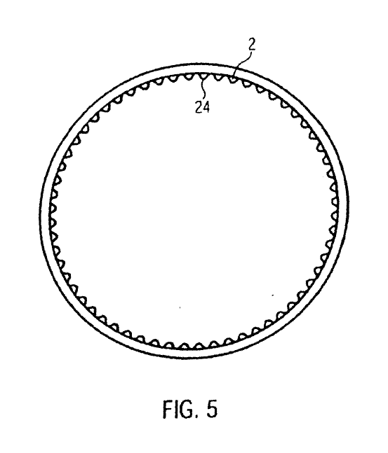

The rib heater 2a, b is advantageously embodied as represented in FIGS. 3 to 5. Here, the side wall has a double wall at least in sections and comprises an outer wall 26a and an inner wall 26b, the thickness d1 of the outer wall being greater than the thickness d2 of the inner wall. The two walls 26a, h are connected to each other at a plurality of joints 25, e.g. by welding, so that unevennesses between the joints occur. The unevennesses for example have the form of a plurality of inflated arched pockets 24 arranged next to and above each other which are in communication with each other and through which the heater medium flows (the inlet and outlet for the heater medium are indicated by the arrows in FIGS. 1 and 2). This means that unevennesses of the heating surfaces result between the joints seen in the cross-section as well as in the longitudinal section, as can be in particular seen in FIGS. 4 and 5. By the formation of these unevennesses, an improved heat transfer to the wort running down can be achieved, having a positive effect on the evaporation of the undesired flavors, while the temperature of the heating medium can be simultaneously held at a minimum. Moreover, micro-circulations (turbulences) arise at the surface of the heating surface, which is equally favorable for the heat transfer and thus for stripping. The temperature of the heating medium which flows in the hollow spaces 27 under the unevennesses or pockets 24, respectively, is selected such that it is some degrees Celsius above the boiling temperature.

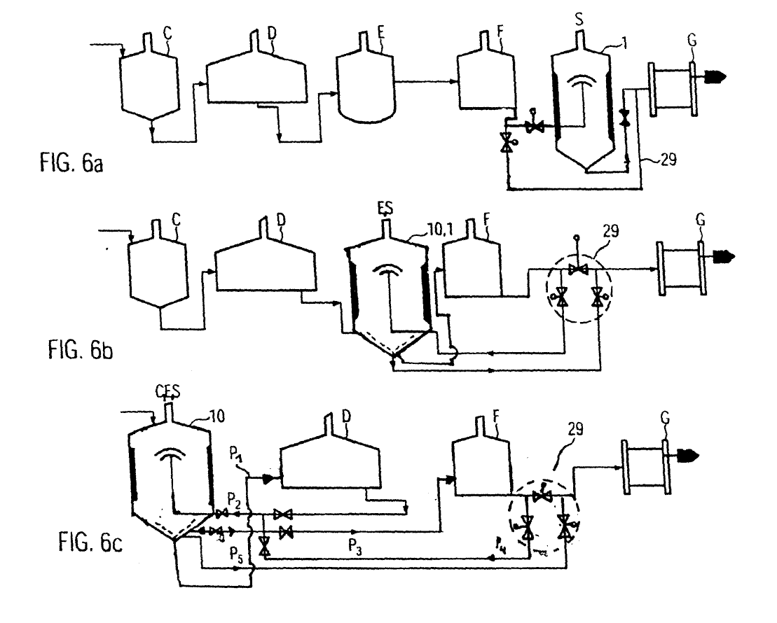

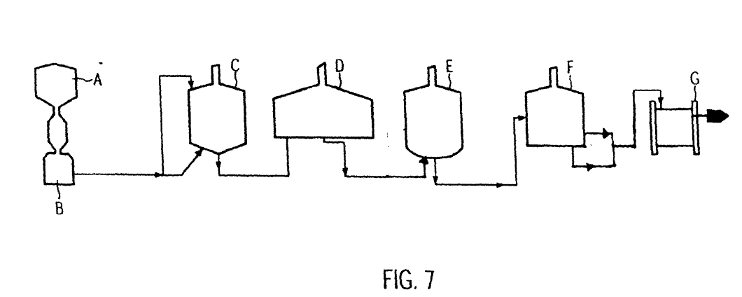

As can be in particular taken from FIG. 6a, this apparatus can be arranged downstream of the hot break separation F, i.e. in particular downstream of the whirlpool. This means that the wort is not, as shown in FIG. 7, supplied from the whirlpool directly to a plate type cooler G, but instead first to the apparatus 1. Advantageously, a bypass device 29 is provided which comprises a bypass line by means of which the wort can be supplied directly from the whirlpool to the cooler (G). By means of directional or control valves, the ratio of stripped wort to unstripped wort can be adjusted.

Though it is not shown, the wort can also be conducted in a cycle through the apparatus, i.e. removed wort is supplied again to the inlet 9 to run down along the heating surfaces of the heater 2a, b several times. By the apparatus 1, volatile matters can be thus removed from the wort in a simple manner.

The apparatus shown in FIG. 1 can also be used as a wort copper. For better heating the wort, a bottom heater could then be provided in the region of the bottom 8, where in addition or as an alternative, an inner or outer boiler can be provided. The inner or outer boiler (not represented) can then further heat the wort circulating in the vessel. Advantageously, the device then also comprises a circulation means, e.g. a pump, which circulates the wort in the receptacle 5. In wort boiling, the filling level preferably rises to the upper region of the heater section 2a. Here, the device 17 is provided as an additional circulation means. The upper end of the inlet pipe 11a adjoins the lower end region of the inlet pipe 11b such that at least one intake is formed between them for sucking in wort from the wort storage in the receptacle 5. Here, e.g. the inlet pipe has a tapered nozzle section at its upper end, so that by the contraction of the cross-section, the speed of the wort flowing through it, or the dynamic pressure, increase and the static pressure decreases. Between the lower end of the rising pipe 11b and the upper end or the outer wall of the inlet pipe 11a, the intake is thus formed and here has an annular design. Due to the low static pressure, wort can be automatically sucked in from the wort storage into the rising pipe 11b via the intake. The sucked in wort then rises upwards in the rising pipe together with the wort supplied via the inlet 9 and flows back into the wort storage. This means that then, as can be taken from FIG. 6b, the apparatus 1 can be used for wort boiling (step E) as well as for stripping. So, after wort boiling, wort is supplied from the device 1 to the whirlpool for hot break separation (step F). After hot break separation, the wort is then again supplied to the apparatus 1 to evaporate volatile matters. Subsequently, the wort is supplied to the cooler for cooling (step G). Here, too, a bypass line 29 can be provided as described in connection with FIG. 6a.

FIG. 2 shows another embodiment of the present disclosure which essentially corresponds to the embodiment represented in connection with FIG. 1, while here, however, the apparatus is embodied as combined mash wort copper. Here, the combined mash wort copper 10 additionally has an agitator 19 in the lower region which comprises at least two rotating blades driven by a drive 20. Furthermore, this apparatus comprises an inlet 18 in the upper region for grind and/or mash. Furthermore, the outlet 13 is divided here e.g. into three lines 21, 22, 23, one of which (21) is used e.g. for filling and draining mash, and another one (23) is embodied as an inlet for partial mash or lautered wort. The line 22 can be used e.g. as wort outlet. The device shown in FIG. 2 is thus used for mashing, wort boiling and stripping. Such an apparatus 10 can also be used as wort copper and stripper as was illustrated in connection with FIG. 6b.

Hereinafter, a possible advantageous process flow is shown with reference to FIGS. 2 and 6c. The mash wort copper shown in FIG. 2 can be used both as mash tun copper and as mash copper. If it is used as a mash tun copper, the mash is homogenously mixed by the existing agitator 19 during the whole mashing process, where the mash can be supplied via the supply 18. If the vessel is used as a mash copper, the partial mash to be boiled is introduced from the bottom for example via line 23 and brought to the boiling temperature by the heater 2a, b and subsequently boiled for a defined period. As illustrated above, a bottom heater can optionally also be provided. Upon completion of the mashing process C, the mash is mashed in the lamer tun for lautering (step D, see arrow P1).

The lautered wort is directed to a first runnings vessel (not represented) or directly into the mash wort copper 10 (see arrow P2). Thus, the wort is heated to the boiling temperature in the mash wort copper 10. Optionally, this can also be done up to a certain temperature by means of an inserted lautered wort heater (not represented). The heating of the wort is accomplished by the heater 2 at the side wall 15 and optionally by means of a bottom heater. The wort can be introduced into the receptacle 5 via an inlet e.g. in the side wall or in the bottom region, while the wort is heated in the wort copper up to a certain wort volume by the heater, and the agitator 19 is employed, so that it is ensured that the wort is homogenous and does not burn on the heating surface. As of a defined wort volume, i.e. if more than ⅓, preferably more than ⅔ of the wort of the corresponding brew, but at least enough for the device 17 to be covered with wort, have been introduced, the wort is preferably directed over the wort inlet 9 and the distributor device 3. Thus, the homogeneity of the copper contents is increased again. Moreover, thorough mixing of the wort results due to the circulation device 17.

After heating, wort boiling is carried out. Here, too, the energy is supplied via the rib heating surfaces 2a, b and the optionally provided bottom heating surface. The wort can be discharged in the lower region, for example via the wort outlet 13 and pumped again towards the distributor device 3 via the inlet 9 (pump is not represented). With the circulation of the wort over the umbrella-type wort distributor 3 during the wort boiling process, one obtains a large surface which results in very effective wort evaporation. Thus, the overall evaporation can be reduced thus improving the wort quality and saving primary energy. Moreover, by the circulation, the homogeneity of the copper contents is ensured.

After the boiling process, the wort is directed into the whirlpool (see arrow P3) for hot break separation (step F).

In contrast to the classic brewhouse process, the wort is now not directed to the wort cooler after the whirlpool but again to the combined mash wort copper 10, see arrow P4. In the process, the wort is introduced via the wort inlet 9 via the distributor device 3. So, the combined mash wort copper here functions, apart from as mash copper and wort copper, also as apparatus for stripping. The distributor device 3 here has the job of letting the wort run down the heated rib in a fine film. By the wort hitting the heating surface, the DMS formed again in the whirlpool is effectively reduced as described above. Here, too, a bypass line 29 can be provided to adjust, as described above, the ratio of stripped wort to unstripped wort. After stripping, the wort then flows to the wort cooler (see P5).

Optionally, the combined mash wort copper can also be designed as whirlpool copper and/or additionally equipped with an inner or outer boiler.

The combined mash wort device can also be employed as continuously operating system.

1. Apparatus for stripping wort where the hot break has already been separated, comprising:
a receptacle which comprises a wort inlet and a wort outlet,
a heater at the side wall of the receptacle and having a heathing surface, and
a distributor device which applies the wort to the heating surface of the heater, such that the wort can run down the heating surface as a film.

2. Apparatus according to claim 1, wherein the apparatus is embodied as one of a mash copper, a wort copper, or a combination thereof.

3. Apparatus according to claim 2, wherein the apparatus comprises one of an agitator, a circulation means which circulates the contents in the receptacle, or a combination thereof.

4. Apparatus according to claim 1, wherein the distributor device is embodied as umbrella-type deflection which is essentially arranged in the central region of the receptacle and directs the wort outwards towards the heating surface.

5. Apparatus according to claim 1, wherein an inward heating surface of the heater has a plurality of unevennesses which communicate with each other and through which a heating medium flows.

6. Apparatus according to claim 1, wherein the apparatus is designed as a pressure tank for overpressure and vacuum.

7. Apparatus according to claim 1, wherein the wort inlet of the apparatus is connected with an apparatus for hot break removal and the wort outlet of the apparatus is connected with a wort cooler, where for adjusting the ratio of stripped to unstripped wort, a bypass means is provided between the whirlpool and the cooler.

8. Method of stripping wort where the hot break has already been separated, comprising, during stripping, distributing the wort on a heating surface at the side wall of an apparatus via a distributor device for stripping and wherein the wort runs down the heating surface from above as a film.

9. Method according to claim 8, and discharging the wort running down at the lower end of the apparatus during stripping.

10. Method according to claim 8, and adjusting the ratio of stripped to unstripped wort.

11. Method according to claim 8, and for manufacturing wort, additionally comprising: mashing, lautering, wort boiling, hot break separation, stripping of volatile matters from the wort, and cooling of the wort.

12. Method according to claim 11, wherein the wort boiling is accomplished in a wort copper, and after hot break separation, again supplying the wort to the wort copper where the wort copper is used as the apparatus for stripping.

13. Method according to claim 11, wherein the mashing is accomplished in a mash copper, and after hot break separation, again supplying the wort to the mash copper where the mash copper is used as the apparatus for stripping.

14. Method according to claim 11, wherein mashing is accomplished in a combined mash wort copper, and again supplying the wort to the mash wort copper for wort boiling after lautering, and after hot break separation, again supplying the wort to the mash wort copper for stripping which is used as the apparatus for stripping.

15. Method according to claim 8, and wherein the temperature of the heating surface is within a range of 103° C. to 130° C., unless in case of pressure boiling, wherein the temperature of the heating surface is higher than 130° C., or in case of vacuum boiling, in which case the temperature of the heating surface is lower than 103° C.

16. Apparatus according to claim 4, wherein the umbrella-type deflection comprises a double umbrella.

17. Apparatus according to claim 5, wherein the plurality of unevenesses comprises a plurality of arched pockets arranged next to and above one another.

18. Apparatus according to claim 7, wherein the apparatus for hot break removal comprises a whirlpool.
